(19) United States
(12) Patent Application Publication
(10) Pub. No.: US 2005/0139332 A1
(43) Pub. Date: Jun. 30, 2005

(54) Overhead door apparatus with enclosed counterbalance mechanism

(76) Inventor: James J. O'Malley, Drexel Hill, PA (US)

Correspondence Address: RATNERPRESTIA, P O BOX 980, VALLEY FORGE, PA, 19482-0980, US

(21) Appl. No.: 10/963,339

(22) Filed: Oct. 12, 2004

Related U.S. Application Data
(63) Continuation-in-part of application No. 10/746,903, filed on Dec. 26, 2003.

(51) Int. Cl. E05D 15/16

(52) U.S. Cl. 160/191

(57) ABSTRACT

An overhead garage door with a counterbalance mechanism incorporated into a pocket or hollow section formed in the door.

### CROSS REFERENCE TO RELATED APPLICATIONS

This Application is a Continuation-in-Part of U.S. patent application Ser. No. 10/746,903 filed Dec. 26, 2003.

### FIELD OF THE INVENTION

The subject invention relates generally to multi-panel doors, such as used as a residential garage door, commercial garage doors, large industrial doors and the like. In particular the present invention relates to such doors which have been reengineered to have a compartment within a door section or panel which houses a counterbalance mechanism responsible for counteracting the effect of gravity on the door as it moves from a closed to an open position and from an open to a closed position.

### BACKGROUND OF THE INVENTION

Overhead doors are not new and are seen frequently in buildings such as homes, automotive shops, barns, aircraft and blimp hangars, commercial warehouses, portable military field structures, and the like. A wide variety of doors are currently used in industrial and other settings. For example, one type of movable door consists of a series of generally horizontal panels disposed one on top of the other with each panel hinged to the panel above. Stemmed rollers are disposed on opposed lateral edges adjacent a bottom and top location of each door panel. Such sectional doors are typically movable between a closed or blocking position and an open or stored position relative to a doorway. For this purpose, guide tracks having a generally “C” shaped cross-section are provided on either side of the doorway for receiving the rollers disposed on the adjacent edges of each of the panels. Each track has a substantially vertical portion disposed adjacent and parallel to the doorway opening, a substantially horizontal portion disposed above and behind the doorway generally perpendicular to the doorway opening, and a connecting curved portion. A track is positioned on either side of the doorway providing a continuous guide track for receiving the stemmed rollers of the adjacent panel sections. In this construction, the door is substantially horizontal when in the open or stored position. Another type of movable door is a vertically storable door which moves in a continuous generally vertical plane between the closed and open (stored) positions along substantially straight and vertical guide tracks disposed from floor level of the door opening to a location above the doorway opening. The lifting force needed to counterbalance the door is recognized to vary so that different types of lifting assist devices are used to provide a statically balanced overhead door i.e. a door that will maintain a position assigned to it by an operator (user). The position can be closed, open or any location in between.

One type of garage door operating mechanism is the so called torsion spring control system. The torsion spring control system uses a shaft around which are disposed control springs to provide the counterbalance for the door. This type of mechanism avoids the use of extension springs but the torsion spring is exposed and can provide a source of injury if repairs or adjustments are attempted by one not skilled in working with such devices.

Another type of counterbalancing mechanism comprises horizontally extendable springs disposed above and generally parallel to the horizontal portion of the guide tracks for counteracting the effect of gravity on the door as it moves between a closed and an open (stored) position or from an open to a closed position. Such counterbalance devices typically include a cable system with a pair of cables attached to the opposite edges of the door with springs connected to each of the cables. In the door open or stored position the spring is not extended, eg. Relaxed or compressed. When the door moves from the stored position, the spring extends or is streched providing a force which counteracts the weight of the door. In this way, the spring controls the descent of the door as it moves toward the closed position. Conversely, when the door is raised from the (doorway-blocking) closed position, the contracting spring provides a lifting force which makes the door easier to raise. Unfortunately, such mechanisms are complicated to assemble, they lack aesthetic appeal and expose the user to potential injury if the spring or cable breaks.

It would therefore, be desirable to house counterbalancing mechanisms within the door itself, thereby providing a more user friendly installation and an aesthetically pleasing door assembly with internal components that are unexposed reducing the potential of injury to a user.

U.S. Pat. No. 6,505,381, teaches using pulleys and a cable in conjunction with a hinge system for deploying panels or other structures from a satellite or spacecraft. The hinge system is placed within a telescoping housing in the deployed position.

U.S. Pat. No. 5,560,658, teaches an overhead bi-fold door with the cable and pulley system within the frame of the door to unlatch the door.

U.S. Pat. No. 6,042,158, discloses a cable actuated locking system inside the body of an overhead door.

U.S. Pat. Nos. 3,774,341 and 4,248,016, teach cable and spring operating systems for overhead doors that are positioned in the frame around the door.

U.S. Pat. No. 1,530,762, teaches a dual race cable drum having an inner race that spools a cable connected to a tensioning member and a larger outer race with separate cables connected to the door bottom.

U.S. Pat. No. 6,134,835 teaches a worm-gear drive winding mechanism to effect the winding of torsion springs on an up-ward acting door. It is supported by brackets attached to the wall above the door, with cables that depend from the counterbalance system and connect to the lower side edges of the door.

U.S. Pat. Nos. 2,291,583; 5,404,927 5,495,640; 6,112,464; 6,263,948 and 6,588,482 teach cable attachment brackets on the bottom edge of an upward acting door to receive the counterbalance cable which lifts the door.

U.S. Pat. No. 6,561,256, teaches opposed independent extension springs and lift cables of an overhead door to synchronize by means of an interconnected drive tube mounted above the door.

U.S. Pat. No. 3,747,274 teaches a cable and spring actuated locking system mounted on a vertically disposed door.

U.S. Pat. No. 5,103,890 teaches an overhead door system to be counterweighted with cables that depend from differential cable drums on a shaft mounted above the door with separate cable drums and cables that depend for attachment on the bottom edge of the door.

U.S. Pat. No. 6,289,966 teaches a door with a counterweight unit mounted on the uppermost door leaf.

U.S. Pat. No. 6,568,454 teaches the counterbalance system mounted above an overhead door to be rotated by an operator motor assembly.

U.S. Pat. No. 1,724,995 teaches an overhead door to be counterbalanced by the resilient action of a torsion spring upon a shaft with flanged pulleys spooling steel tape attached to the bottom of the door.

U.S. Pat. No. 1,059,981 teaches a bi-fold warehouse door to lift by chains secured to the bottom of the door with separated lateral bearing studs.

U.S. Pat. Nos. 1,724,995 and 2,882,044, teach operating the torsion shaft of a counterbalance assembly above a door to be rotated by an operator motor.

U.S. Pat. No. 1,661,719 teaches an endless chain driven by a motor carry to a trolley or carriage which is movable to the front and rear of a T-irons runway above an overhead door with the carriage linked to the door, whereby the door may be pulled or pushed effecting the opening and closing of the door.

U.S. Pat. No. 2,253,170 teaches an electric motor to turn a drive screw which carries a nut affixed to a carriage that travels forward and backward on a channel above a garage door and opens and closes the door.

The above two patents do not teach a linear drive motor mechanism to be significantly shorter in length as the distance the extension spring extends or retracts is far less in proportion to the full length of travel of the door. The length of a typical chain or screw drive opener mounted above a door is 10′. The length of the extension of the spring on the same door would be 3.3′ or approximately ⅓ the distance of travel. Further mechanical control of speed and force will be recognized as well.

U.S. Pat. Nos. 2,015,402; 2,568,808 and U.S. Pat. No. 5,036,899 teach a lateral shaft mounted on the top section of an overhead door to rotate with tension applied to the shaft by torsion spring means and pinions outboard of the lateral edges of the door which engage racks along the door tracks effecting the counterbalance of the weight of the door with rotation of the lateral shaft by a motor carried on the door.

U.S. Pat. No. 2,676,294 teaches opposed independent extension springs and lift chains of an overhead door to synchronized by combining sprockets on a shaft, above the door, to unify the lift chains and further permit rotation of the shaft directly by a motor assembly.

U.S. Pat. No. 4,468,904 teaches functionally connected torsion springs to counterbalance a telescoping tower.

U.S. Pat. No. 5,577,544 teaches a cable reeling device to affect the extension of a spring parallel with the horizontal track of an overhead door. An extension spring containment tube which surrounds the entire periphery of an extension spring over its operational length is also disclosed.

U.S. Pat. No. 5,632,063 teaches a worm drive ring shaped gear winding mechanism to affect the winding of torsion springs above an overhead door.

U.S. Pat. No. 1,508,886 teaches providing garage door units which may be assembled, in part, at a factory and shipped to a garage to be easily and quickly installed, that affords a safe and durable closure for the garage.

None of the prior art teach or suggest a garage door having a novel or conventional counterbalance mechanism enclosed within a panel of the door nor cables and pulley systems within a panel of the door with the cable exiting the door to a fixed location outside of the door.

### SUMMARY OF THE INVENTION

The present invention pertains to an overhead door system of the type having a multi-panel door with at least one hollow or enclosed door section; the door being moveable between a closed vertical position and an open generally horizontal position relative to a doorway; and a counterbalance mechanism housed within the hollow or enclosed section of the door to facilitate the movement of the door between open and closed positions. The counterbalance mechanism within the hollow door section replaces conventional torsion spring counterbalance mechanisms associated with overhead type doors which are mounted outside of the door either above the door frame, or extension spring mechanism with each extension spring mounted parallel to each of the guide rails.

In its broadest aspect the present invention is an overhead door within least one hollow door section containing and enclosing a counterbalance mechanism therein for counteracting the effect of gravity on the door and for controlling the movement and positioning of the door between the open and closed positions.

In one embodiment of the present invention is a vertically moveable door having at least one hollow door section containing a counterbalance mechanism therein, the counterbalance mechanism having a torsion means, cable drums fixed to each end of the torsion spring means, a cable spooled around each drum, and a plurality of direction transfer pulleys, wherein the cable passes around direction transfer pulleys out of hollow door section to a fixed point above the door.

In another embodiment of the present invention, an overhead door is positioned in fixed tracks disposed on either side of the door, with the door having at least one hollow door section containing a counterbalance mechanism therein, the counterbalance mechanism including extension spring means, at least two pulleys one of which is fixed to one end of the extension spring, cables attached to fixed points within the hollow door panel and running through the pulleys and exiting the sides of the hollow door section to fixed points above and adjacent to either side of the door.

Therefore a goal of the present invention is to provide an overhead door wherein the counterbalance mechanism is enclosed within the door itself.

Another goal of the present invention is to provide an overhead door with a counterbalance assembly within an enclosed portion of the door itself without modifying existing track configurations for mounting the door.

### BRIEF DESCRIPTION OF THE DRAWING

FIG. 1 is a rear perspective view of an overhead door assembly according to the present invention with the door in a closed position, portions of the door cutaway to reveal a counterbalance mechanism according to the invention contained therein.

FIG. 2 is a rear elevational view of the overhead door assembly of FIG. 1 with a bottom inside panel cover removed to show a torsion spring counterbalance mechanism according to the present invention.

FIG. 3 is a rear elevational view of alternate embodiment of a counterbalance mechanism for an overhead door assembly according to the present invention.

FIG. 4 is a rear perspective view of an overhead door assembly according to the invention with the door in a closed position showing an alternate fixed spring counterbalance assembly according to the present invention.

FIG. 5 is a rear perspective view of an overhead door and counterbalance assembly according to the present invention utilizing a freely suspended spring counterbalance assembly.

FIG. 6 is a fragmentary rear elevational view of an alternate overhead door and counterbalance assembly according to the invention.

FIG. 7 is an enlarged fragmentary view of a bottom pulley assembly according to the present invention.

FIG. 8 shows an alternate embodiment of the bottom pulley assembly according to the present invention.

### DETAILED DESCRIPTION OF THE INVENTION

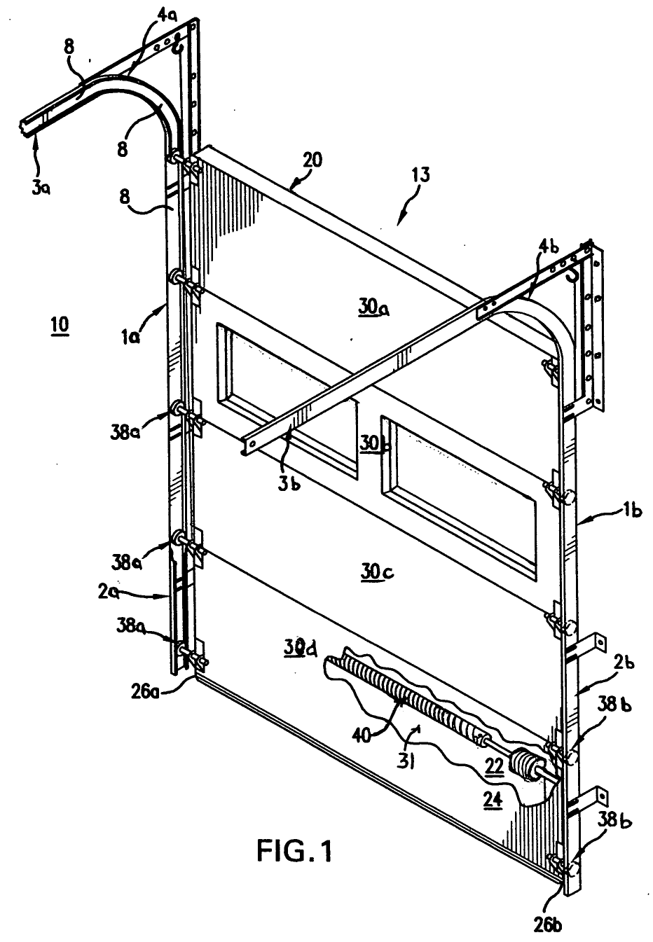

Referring to FIG. 1, an overhead door according to the present invention is shown generally by the numeral 10. FIG. 1 depicts a residential or commercial overhead garage door for the purposes of illustration. The overhead door assembly 10 is an integral unit and includes a vertically moveable door 20 consisting of door sections 30a, 30b, 30c and 30d with at least one section (eg. 30d) covered with a panel, panel or panel cover 24 to create a hollow door section 31 for enclosing therein the counterbalance mechanism 40 as described in greater detail below. While door 20 is described in relation to one cover or panel 24, each door section 30a, 30b, 30c and 30d is fitted with a like panel to create a fully hollow door.

Door 20 is moveable relative to a doorway, indicated by arrow 13, between a closed or blocking position and an open or stored position. In the embodiment illustrated in FIG. 1, door 20 consists of four door sections 30a, 30b, 30c, 30d in series, placed one on top of another, and hinged together as is known in the art. However, hollow door section 31 is created in the bottommost panel 30d by including the cover 24. Hollow door section 31, is created by front panel 22, rear panel 24, and opposed lateral edges or side stiles or stiffeners 26a, 26b of bottommost panel 30d. A pair of side-mounted guiding elements or lateral end members in the form of rollers 38a, 38b are positioned perpendicular to lateral edges 26a, 26b of door section 30d for rolling engagement within a pair of guide tracks 1a, 1b having a generally “C” shaped cross-section mounted on each side of the doorway 13. Identical roller elements are positioned on either side of each of the door panels 30a, 30b, and 30c. Door panels 30a, 30b, 30c, 30d may be flat or embossed or contain windows as shown in FIG. 1 in relation to the panel 30b, second from the top of door 20. In the embodiment of FIG. 1, each guide track 1a, 1b includes a first segment 2a, 2b which extends substantially vertically parallel to the sides of the doorway 13. A second overhead or horizontal 3a, 3b of tracks 1a, 1b extends substantially perpendicular to the doorway 13, and curved segments 4a, 4b connect the vertical and horizontal portions of tracks 1a, 1b to form continuous paths for the door rollers. Each guide track 1a, 1b receives guiding members or rollers 38a, 38b of door 20, which are positioned within and adapted to run along the entire length of guide tracks 1a, 1b as is known in the art.

Although door 20 described and illustrated in FIG. 1 consists of a plurality of hingedly attached door sections 30a, 30b, 30c, 30d, it will be readily appreciated by those skilled in the art that door 20 may take other forms without departing from the scope or spirit of the present invention. The hollow door section 31 housing the counterbalance mechanism may contain insulation disposed around the mechanism. Door 20 may also be a single insulated or non-insulated hollow structure (i.e., a non-hinged door). It will also be appreciated that the guiding members or rollers 38a, 38b for door 20 may take other forms including, for example, pins with rounded heads which are received by guide tracks 1a, 1b. Alternatively, lateral edges 26a, 26b of door sections 30a, 30b, 30c, 30d could form the guiding members by having a boss or other structural member directly received in the guide tracks 1a, 1b. In addition, the guide tracks 1a, 1b may alternatively be completely straight and vertical, as opposed to curved. In this way, door 20 would be disposed vertically in both the closed and open positions facilitating the use of a one-piece door.

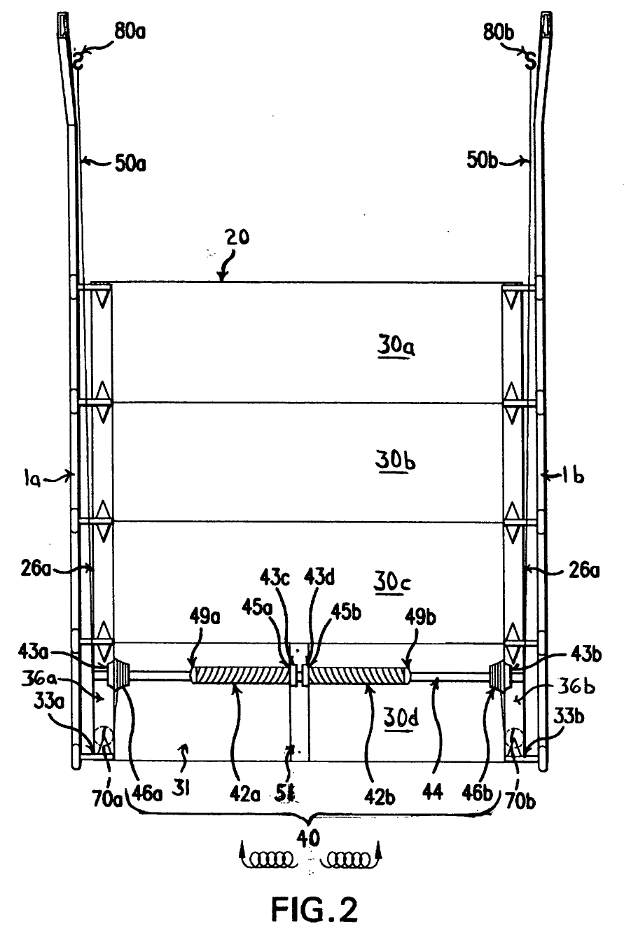

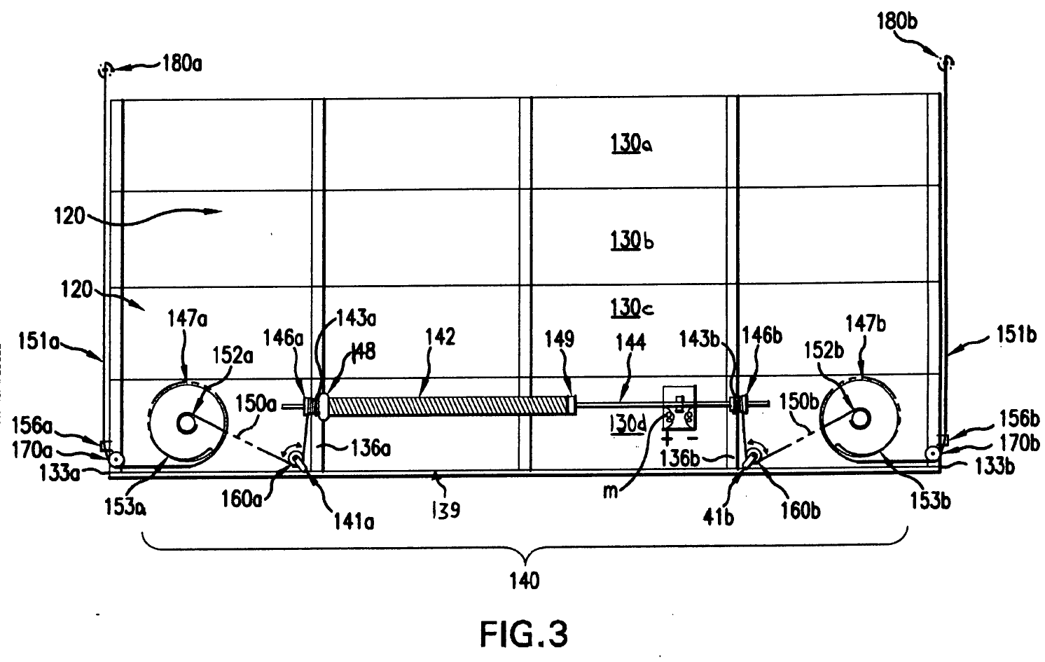

Referring to FIG. 2, counterbalance mechanism 40 is disposed on the inside of lowermost panel 30d of door 20 for controlling movement of or counteracting the effects of gravity as door 20 moves between an open (not shown) and closed position and to overcome the weight of the door as it moves between the closed and open positions. Counterbalance mechanism 40 may be constructed in numerous ways and housed inside of the door itself by providing a cover panel 24 (FIG. 1) spaced apart from the inside of face 22 of lowermost panel 30d. In a first embodiment, counterbalance mechanism 40 consists of a pair of torsion springs 42a, 42b which are disposed around support shaft 44. A pair of spaced-apart cable drums 46a, 46b are mounted at opposite ends of support shaft 44, and a pair of cables 50a, 50b have one end fixed to drums 46a and 46b respectively and on an opposite end are fixed to the structure supporting the rails 1a, 1b at a location above the door 20 by hooks 80a and 80b so that cables 50a and 50b are generally vertical and parallel to vertical portions 2a and 2b of tracks 1a, 1b (FIG. 1). Support shaft 44 is rotatably mounted on door 20 at the opposite ends by shaft support bearings 43a, 43b. Springs 42a, 42b may be helical torsion springs or other suitable springs or tensioning devices known to those skilled in the art. One end of each spring 42a, 42b is positioned on shaft 44 by adjustable positioning cones 49a, 49b. The opposite ends of each spring 42a, 42b are positioned by stationary mounting cones 45a, 45b which also support position or hold shaft bearings 43c, 43d. The stationary mounting cones 45a, 45b can be attached or to a support or stiffener 51 located in the center of panel 30d of door 20. As may be appreciated a single torsion spring 142 (FIG. 3) may be substituted for the pair of springs 42a, 42b of FIG. 2. Support shaft 44 is rotatably mounted within hollow door section 31 of panel 30d, with the axis of rotation of cable drums 46a, 46b substantially perpendicular to the opposed lateral edges 26a, 26b of hollow door section 31 of panel 30d. A length of cable 50a, 50b is fastened at one end to its respective cable drum 46a, 46b and the free end wound around the respective drum. The free ends of cable 50a, 50b then extend downward to the lowermost corners of hollow door section 31 where they pass through bottom pulley fixtures 70a, 70b and directed out of door 20 through apertures 33a, 33b in door stiles or stiffeners 36a and 36b and upward to fixed points 80a, 80b above door 20. Although flexible elements 50a, 50b are described herein as cables, it will be appreciated by those skilled in the art that cables 50a, 50b can be replaced by, for example, cords, ropes, belts, chains, and the like.

Counterbalance mechanism 40 of FIG. 2 not only controls the descent of the door 20 as it moves downwardly from the open position, but it also makes the door 20 easier to raise from the closed position. For example, when the door 20 moves towards the closed position, the support shaft 44 rotates about its axis, the cables 50a, 50b progressively unwind from the cable drums 46a, 46b, and springs 42a, 42b become increasingly tensioned by compression of. This tensioning of 15 springs 42a, 42b, in turn, causes cables 50a, 50b to exert a force on door 20 which partially counteracts its weight. In this way, counterbalance mechanism 40 controls the descent of door 20 as it is moved from the open to the closed position. Conversely, when door 20 is lifted from the closed position, the energy stored in tensioned springs 42a, 42b provides a force which makes it easier to elevate door 20. Springs 42a, 42b, unwind or are counter tensioned by counter-rotation of shaft 44. In any position, tension is continuously maintained in cables 50a, 50b as door 20 moves between the open and closed positions or vice versa. If, cables 50a, 50b were to fail or become too slack, counterbalance mechanism 40 would no longer be able to aid in controlling the upward or downward movement of door 20.

In the embodiment shown in FIG. 3 the counterbalance mechanism 140 includes dual race cable pulleys or drums 147a, 147b to overcome the limitation that the diameter of each cable drum 146a, 146b is limited to that which will fit within the thickness of hollow door section 130d. Accordingly, cable drums 146a, 146b will have a relatively limited cable storage capacity. When the desired mechanical advantage can not be achieved with the capacity of the respective cable drums 146a, 146b (e.g. for a fully vertical left door) the addition of an intermediate cable spooling apparatus may be employed to resolve this problem as described in detail below.

As shown in FIG. 3, counterbalance mechanism 140 helps the user to open and close door 120. In this embodiment, counterbalance mechanism 140 includes a single torsion spring 142 which is rotatably mounted around a support shaft 144. Support shaft 144 is rotatably mounted to door 120 at opposite ends thereof by shaft support bearings 143a, 143b. Support bearings 143a, 143b are mounted to vertical stiles 136a, 136b which reinforce the structural integrity of door 120 generally and hollow door section 130d in particular. A pair of spaced-apart cable drums 146a, 146b are mounted at opposite ends of support shaft 144, and a pair of cables 150a, 150b are fixed on one end to the drums 146a, 146b. Spring 142 may be single helical torsion spring or other suitable spring or tensioning device known to those skilled in the art. Spring 142 may be replaced by a pair of springs mounted around support shaft 144similar to the construction of FIG. 2.

A gear reduction device 148 may be used to control tension on spring 142 by permitting one end of spring 142 to rotate at different rates in relation to an opposite end which is fixed onto cone 149 mounted on fixed shaft 144.

The axes of cable drums 146a, 146b are substantially perpendicular to vertical stiles 136a, 136b of hollow door section 130d of door 120. Cables 150a, 150b having one end fixed to its respective cable drum 146a, 146b are wound around each drum and passed around pulleys 160a, 160b respectively which are pivotally mounted by clevises 141a, 141b to a bottom rail 139 of door section 130d below each cable drum 146a, 146b, and then to inner races 152a, 152b respectively of dual race cable drums 147a, 147b where the opposite ends of cables 150a, 150b are wound around and fixed to inner races 152a, 152b of dual race cable drums 147a and 147b respectively. A second pair of cables 151a, 151b having one end fixed to and wound about the outer races 153a, 153b of dual race cable drums 147a, 147b have the free ends passed around pulleys 170a and 170b which are mounted for rotation about an axis generally perpendicular to and fixed in the lowermost corners of door section 130d. The free ends of cables 151a, 151b are directed out of section 130d of door 120 through apertures 133a, 133b through cable guides 156a, 156b and upward to fixed points 180a, 180b above the doorway. The diameter of the outer races 153a, 153b may vary relative to the diameters of the inner races 152a, 152b of each dual race cable drums 147a, 147b to permit adjustment of tension and to provide a desired mechanical advantage. Dual race cable drums 147a, 147b are mounted on shafts generally perpendicular to support shaft 144, thereby solving the problem of the maximum permissible size of cable drums 146a, 146b which are fixed by the thickness of door section 130d with a panel cover in place,such as shown as 31 in FIG. 1. Theoretically the size of dual race cable drums 147a, 147b is limited only by the height of door panel 130d. It will be recognized that gear reduction device 148 can deliver motion from tensioning of spring 142 directly to cable drums 147a, 147b giving a user the option of sizing the drum and delivering the winding force around a perpendicular axis. A workable ratio of diameters of outer races 153a, 153b to inner races 152a, 152b is 4:1, although any ratio of outer race (153a, 153b) diameter to inner race (152a, 152b) diameter including using spiraling diameters to provide a desired mechanical advantage can be used. Cables 150a, 150b and 151a, 151b may replaced by, for example, cords, ropes, belts, chains, and the like. Although cable guides 156a. 156b can be u-bolts, other cable guide means such as cable snubs or idler pulleys can be used. A motor m, incorporated into the door section 130d, may be coupled to support shaft 144 to achieve remote controlled operation of the door 120.

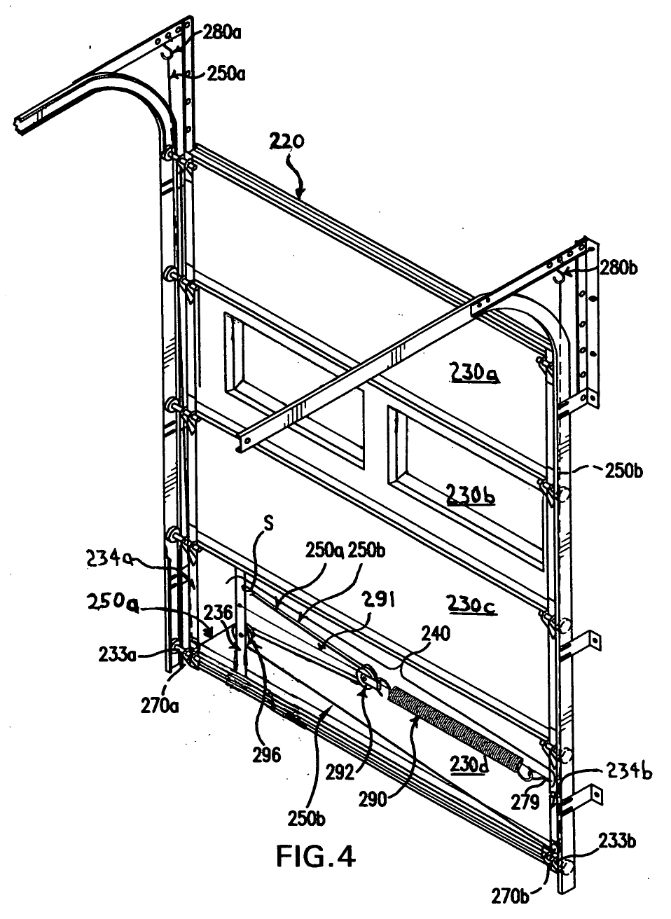

As shown in FIG. 4, counterbalance mechanism 240 of door 220 includes a generally horizontally disposed extension spring 290 contained within door section 230d and attached at one end to a fixed location therein via means 279. Spring attachment means 279, is shown in FIG. 4 as a hook, but other conventional attachment means can be used. A dual pulley 292 is attached by a conventional means to the free end of extension spring 290 is positioned by and supported by cables 250a, 250b as described below. Cables 250a, 250b having one end fixed at a point along the length of vertical stile 236 using an S shaped-hook or other suitable means extend partially around dual pulley 292. The free end of cable 250a is passed around pulley 296, which is mounted for rotation at a fixed point along the length of vertical stile 236, and then through bottom pulley fixture 270a, out of door section 230d via aperture 233a in vertical side stile 234a, and then upward to fixed point 280a above door 220. In like fashion, the free end of cable 250b passes around dual pulley 292 and then around pulley 296, and thereafter through bottom pulley fixture 270b, out of door section 230d through aperture 233b in vertical side stile 234b, and then upward to fixed point 280b above the door 220. The common paths of cables 250a, 250b from point S around dual-pulley 292 permits extension of spring 290 to exert equal tension in each of cables 250a, 250b. The vertical run of cables 250a and 250b exiting door section 230d are kept plumb and adjacent to the outer edges of door 230 by position and control spring 290. The linear extension of spring 290 and movement of cables 250a, 250b may be controlled by the addition of motor drive (i.e. screw or chain drive) inside of the door section 230d itself. Although spring 290 is described as a single spring, any number of extension springs may be combined in tandem or side by side. Other arrangements including use of springs of different diameters, one inside the other are within the scope of the present invention. A safe practice would be to run a taut stationary cable, bar or the like 291 through extension spring 290 with cable 291 extended parallel to a central axis of spring 290 from stile 236 to stile 234b the event of spring or cable breakage. A sleeve could also be placed around all or portions of extension spring 290 to form a compartment to contain the spring in the event of breakage. Such a sleeve would be fixed to the outer panel of door section 230d. Alternatively a shelf or other support fixed to door section 230d could be placed beneath spring 290.

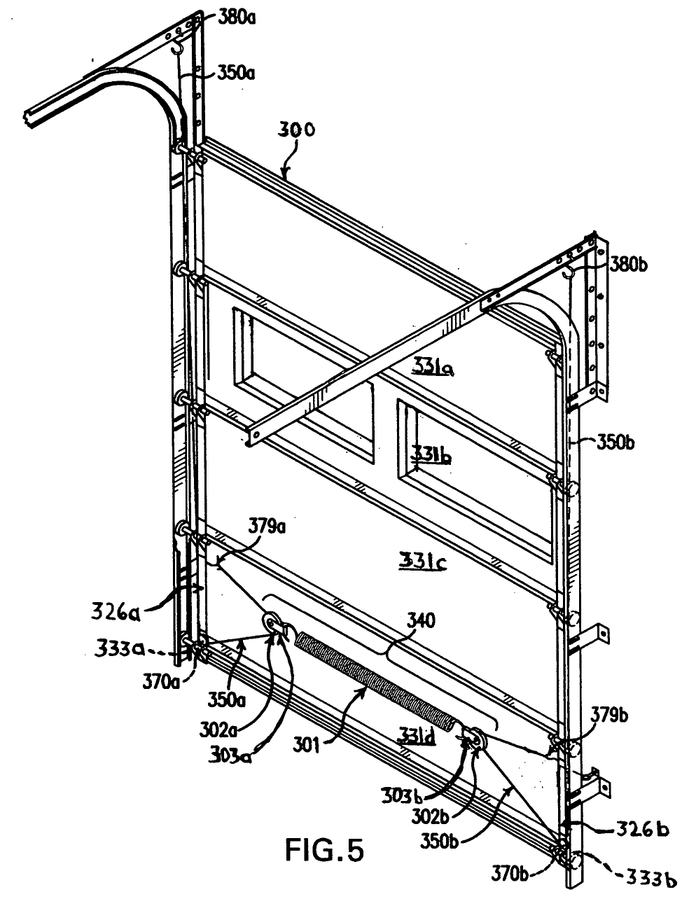

As shown in FIG. 5, another counterbalance mechanism 340 disposed in generally horizontal position within section 331d of door 300. Horizontally disposed extension spring 301 with pulleys 302a, 302b attached at either end is free-floating and suspended within hollow door section 331d by means of cables 350a and 350b. Pulleys 302a, 302b are shown as attached to a hook shaped portion formed in the opposite ends of extension spring 301 by means of a clevis (eg. 303a, 303b) and positioned by means of cables 350a and 350b. Attachment of pulleys 302a and 302b may take other forms as would be apparent to a worker skilled in the art. Cables 350a, 350b are fixed respectively to side door stiles 326a and 326b of door section 331d at locations 379a, 379b using an S-hook or other suitable means. Cables 350a, 350b can alternatively be anchored to vertical stiles adjacent to stiles 326a and 326b or any other suitable points within hollow door section 331d. Cables 350a, 350b are passed around pulleys 302a, 302b respectively and thereafter through bottom pulley fixtures 370a, 370b respectively and, out of the hollow door section 331d through suitable apertures (333a, 333b) in vertical stiles 326a and 326b of section 331d of door 300 to fixed points 380a, 380b above door 300. As shown in FIG. 5 the free ends of cables 350a and 350b are fixed to a bracket fixed to each of the door tracks by S shaped hooks. The cables 350a, 350b can also be fastened to the door frame or the building structure surrounding the door frame or door opening. A safety bar or cable such as illustrated in relation to the embodiment of FIG. 4 can be used to control movement of the spring 301 in the event one or more of cables 350a, 350b breaks or becomes slack or spring 301 breaks.

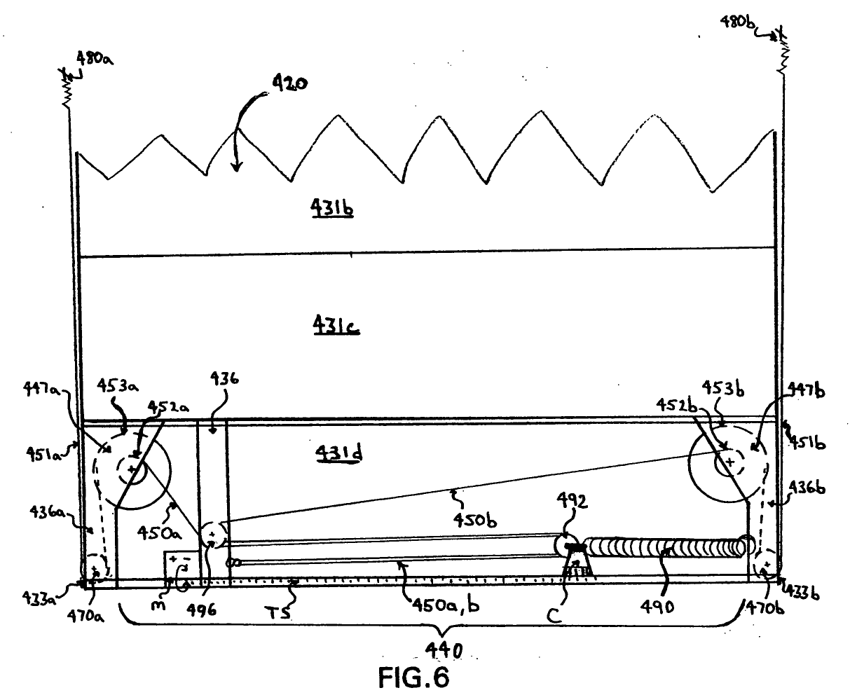

It may be readily appreciated that the counterbalance mechanism 240 (FIG. 4) may be further enhanced by combining the advantage gained by counterbalance mechanism 140 (FIG. 3) through the use of dual race cable drums. As shown in FIG. 6, an alternate counterbalance mechanism 440 is provided for controlling movement of door 420 as it moves between the open and closed positions or vice versa. Counterbalance mechanism 440 consists of a relatively horizontal extension spring 490 having one end attached by conventional means to a fixed location on end stile 436b. Stile 436b is fabricated to position spring 490 and to position dual race cable drum 447b. One end of cables 450a, 450b are fixed to vertical stile 436 by conventional means and then passed around dual pulley 492 and back to dual pulley 496 mounted at a second location on vertical stile 436. The free ends of cables 450a, 450b are then directed respectively to inner races 452a, 452b of dual race cable drums 447a, 447b. Cables 450a, 450b are wound around and fixed to their respective inner races (452a, 452b). A second pair of cables 451a, 451b are fixed to and wound about the outer races 453a, 453b of dual race cable drums 447a, 447b and run to the lowermost corners of door section 431d where they pass through bottom pulley fixtures 470a, 470b and are then directed out of door 420 through apertures 433a, 433b and upward to fixed points 480a, 480b above the door 420. The energy delivered to inner races 452a, 452b will be transferred to outer races 453a, 453b and a mechanical advantage will be gained in order to allow the extension of spring 490 to effect balance of door 420 from the full open to the full closed position. Spring sizing and the ratio of inner races to outer races of the dual race cable drums may vary and can be selected for optimal mechanical advantage by those skilled in the art. FIG. 6 includes the addition of motor drive M which rotates threaded shaft TS which runs parallel to spring 490. The rotation of shaft TS causes carriage C to traverse shaft TS by means of a nut engaging shaft TS. Carriage C is connected to extension spring 490 and the movement will cause the extension or retraction of spring 490, thereby enabling remote opening and closing of door 420. The apparatus of FIG. 6 is ideally suited for use in a large overhead door such as found in automotive repair shops where the door itself must move in a substantially vertical plane prior to the door sections changing direction for horizontal storage in the open position.

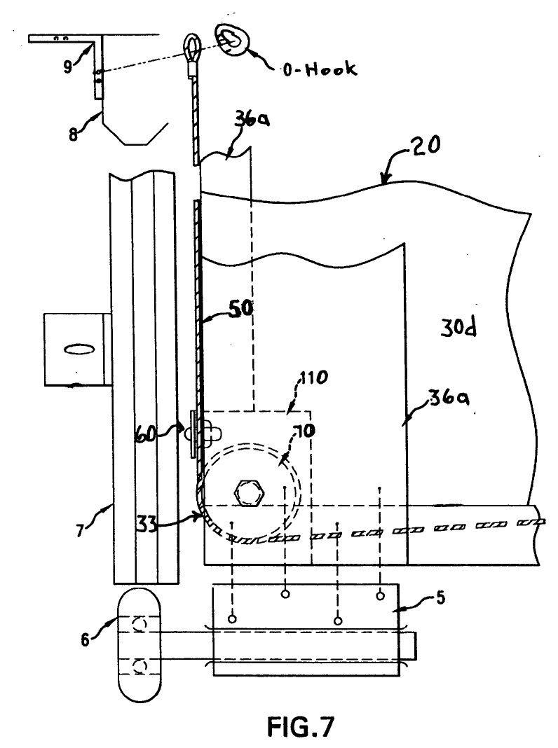

FIG. 7, is an enlarged fragmentary view of one type bottom pulley fixture 110 which can be fixed to a lower corner of door section 30d, (and also 130d, 230d, 331d or 431d) in a manner so that pulley 70 of fixture 110 projects slightly outside of the vertical side stile 36a of door section 30d. Cable 50 passes around pulley 70 and out of aperture 33 of stile 36a to a fixed point 80 and attached by conventional means. A cable snub 60 may guide cable 50 to provide a vertical and generally plumb orientation of cable 50 from the bottom of door 20 to the fixed point 80 above the door opening. Although bottom pulley fixture 110 is in the form of an independent part it may formed as an integral part of the end stile 36a during construction of door section 30d. Roller carrier 5, stemmed roller 6, vertical track 7, horizontal truck 8, and horizontal angle 9 are shown for orientation to door 20.

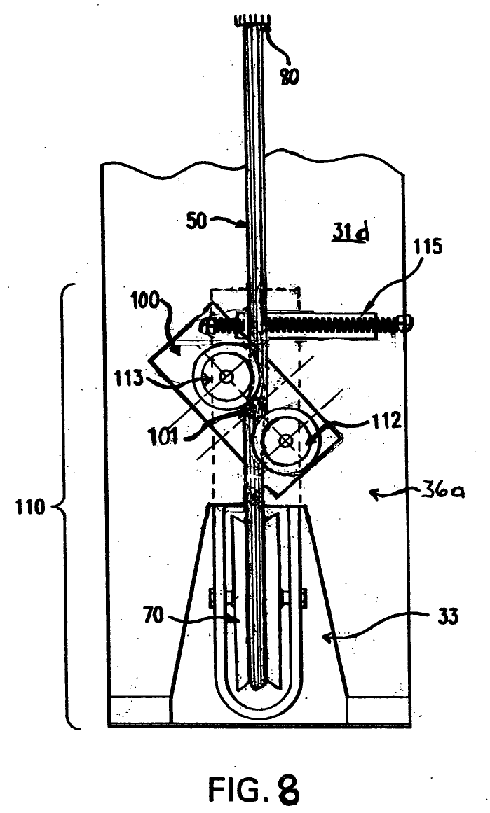

FIG. 8, is an enlarged section of a mechanism for use with the device of FIG. 7 to maintain vertical orientation of cable 50 as it passes out of hollow door section 31d through aperture 33. As with the device of FIG. 7 cable 50 passes around pulley 70 out of aperture 33 to fixed point 80. Idler cam 100 is mounted for rotation about a center point 101 fixed on an outside face of stile 36a with control spring 115 to bias pivoting of the idler cam 100 about point 101 to maintain cable 50 and in a vertical orientation between pulley 70 and point 80. Cable 50 passes between pulley 112 and pulley 113 on idler cam 100 and thereafter to fixed point 80. Movement of idler cam 100 is controlled by spring mechanism 115 to maintain the vertical orientation of cable 50.

The present invention enables a user to use conventional steel roll formed door sections with a thickness ranging from 2 inches to 6 inches by modifying them to accept a counterbalance mechanism according to the invention without substantial retooling of manufacturing equipment. Further, the counterbalance mechanism of the invention may be utilized with door sections of greater or lesser thickness through modification of the door and back cover panel using reinforcing members and associated hardware.

The present invention provides a counterbalance mechanism for overhead doors using a single extension spring enclosed in a section of a door wherein the spring is suspended between the cables, the spring and cable assembly permitting control of the movement of the door during opening and closing of the door.

The present invention provides a counterbalance mechanism for an overhead door using one or more extension springs positioned in an enclosed portion of the body of an overhead door section, the springs and cable assembly permitting control of the movement of the door during opening and closing of the door manually or with the addition of a drive motor.

The present invention provides a counterbalance mechanism within an enclosed portion an overhead door using a torsion spring assembly inside the body of the door, or a section of the body of the door, the torsion spring assembly acting as the counterbalancing mechanism of the overhead door to control movement of the door during opening and closing of the door.

The present invention provides a counterbalance mechanism for overhead (vertically moveable) doors, using a torsion spring assembly whereby force may be applied to or relieved from a torsion spring assembly by a gear reduction device, the entire mechanism disposed within a hollow door section, the assembly acting to control movement of the door during opening and closing of the door with or without the addition of a rotary drive motor.

Although this invention has been disclosed in the context of certain embodiments and examples, it will be understood by those skilled in the art that the present invention extends beyond the specifically disclosed embodiments and/or uses of the invention and that the scope of the present invention herein disclosed should be limited only by a fair reading of the appended claims.

1. In a garage door movable from one of a generally vertical closed position to a generally vertical or horizontal open position and returnable to an original position the improvement comprising:
incorporating a counterbalance mechanism on an inside surface of the door, the counterbalance mechanism enabling the door to be more easily moved and maintained in any position from fully open to fully closed or in between fully open and fully closed the, counterbalance mechanism utilizing cables having one end connected to the counterbalance mechanism and the other end to one of means supporting the door or the structure surrounding the door.

2. A garage door according to claim 1 wherein the counterbalance mechanism is incorporated into a generally closed compartment formed in the door.

3. A garage door according to claim 2 wherein the compartment is formed using one panel of a multiple panel door covered by a removable cover panel, the panel and cover panel defining a hollow cavity to receive the counterbalance mechanisms.

4. A garage door according to claim 1 wherein the counterbalancing mechanism includes a torsion spring to control winding and unwinding of the cables.

5. A garage door according to claim 4 wherein the counterbalance mechanism includes dual race cable drums and dual cables to effect control of movement of the garage door.

6. A garage door according to claim 1 wherein the counterbalancing mechanism includes an extension spring connected to the cables to control movement of the garage door.

7. A garage door according to claim 6 wherein the counterbalance mechanism includes dual race cable drums and dual cables to effect control of movement of the garage door.

8. A garage door according to claim 1 wherein said counterbalance mechanism is motor actuated.

9. A garage door according to claim 1 wherein the cables extend from the counterbalance mechanism out of a lowermost location on either side of said door via transfer pulleys to said means supporting the door or the structure surrounding the door.

10. An overhead garage door positioned in fixed tracks disposed on either side of the door, the door having at least one hollow door section proximate a lowermost section of the door, the hollow door section containing a counterbalance mechanism, the counterbalance mechanism including a pair of cables that have one end fixed to the counterbalance mechanism the free end of each of the cables extending from said counterbalance mechanisms through a pulley fixed adjacent opposite sides of the door, adjacent a bottom location of the door, the cables directed out of the door panel to fixed points above and adjacent either side of the door.

11. A garage door according to claim 10 wherein the counterbalance mechanism includes at least one torsion spring.

12. A garage door according to claim 10 wherein the counterbalance mechanism includes at least one extension spring.

13. A vertically moveable multi-section door having at least one hollow door section containing a counterbalance mechanism therein, the counterbalance mechanism having a torsion means, cable drums fixed to each end of the torsion spring means, a cable spooled around each drum, and a plurality of direction transfer pulleys, each cable passing around a direction transfer pulley out of an opposite side of the hollow door section to a fixed point above the door.

14. An overhead door of the type positioned in fixed tracks disposed on either side of the door, the improvement comprising, the door having at least one hollow door section containing a counterbalance mechanism therein, the counterbalance mechanism including extension spring means, at least two pulleys each of the pulleys fixed to an opposite end of the extension spring, cables attached to fixed points within the hollow door panel and running through the pulleys and exiting the sides of the hollow door section to fixed points above and adjacent to either side of the door.
